(19) United States
(12) Patent Application Publication
(10) Pub. No.: US 2009/0271719 A1
(43) Pub. Date: Oct. 29, 2009

(54) SYSTEM AND METHOD FOR ANALYSIS AND DISPLAY OF GEO-REFERENCED IMAGERY

(75) Inventors: John J. Clare, Rochester, NY (US); David P. Russell, Canandaigua, NY (US); Christopher W. Wolfe, Macedon, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: LPA SYSTEMS, INC., Fairport, NY (US)

(21) Appl. No.: 12/441,621

(22) PCT Filed: Mar. 24, 2008
(86) PCT No.: PCT/US2008/003822

§ 371 Date: Mar. 17, 2009

Related U.S. Application Data
(60) Provisional application No. 60/926,735, filed on Apr. 27, 2007.

(51) Int. Cl. G06F 3/00

(52) U.S. Cl. 715/762

(57) ABSTRACT

An improved system and method for analysis and display of geo-referenced imagery overlaid with information such as vegetation health, land cover type and impervious surface coverage. In one aspect, an image analysis system creates a map of a selected area of land by overlaying information extracted from an image or images onto a base map or image. In another, a spatially-indexed image database is maintained having a plurality of images corresponding to a plurality of geographic locations; a user-specified geographic location is accepted through an interactive graphical user interface; a user-specified extraction analysis is accepted for application upon one or more images; a user-specified extraction analysis is automatically executed to extract overlay information from such images corresponding to user-specified geographic location(s); and extracted overlay information is overlaid on a geo-referenced image, and displayed though a graphical user interface.

### PRIORITY CLAIM

The present application claims priority to Provisional Patent Application No. 60/926,735, filed Apr. 27, 2007.

### TECHNICAL FIELD

The present invention relates generally to the analysis and display of geo-referenced imagery and, more particularly, to a system and method for creating an image or map of a selected area of land by overlaying information (e.g. land cover type, impervious surface coverage, or health of vegetation) extracted from an image or images onto a base map or image.

### BACKGROUND OF THE INVENTION

Petabytes of remotely sensed imagery are collected every year for government and commercial purposes, comprising vastly more information than is actually utilized. Useful analysis of this information requires skilled professionals and complex tools.

Imagery collected by satellite and aerial platforms can provide a wealth of information useful for understanding many different aspects of the environment. Given the appropriate tools and skilled analysts, visible, color infrared, multispectral and hyperspectral imagery can be used to explore and understand issues ranging from socio-economic to environmental. Unfortunately, a lack of skilled analysts often prevents agencies or organizations from taking advantage of the knowledge that could be gained through the use of available imagery.

Even the most skilled analyst may have difficulty interpreting imagery. Each type of imagery presents different challenges for an analyst. Standard visible imagery is the easiest for most people to understand since it essentially mimics the human visual system. Beyond that, multispectral and hyperspectral images require more experience and a deeper understanding of the reflectance behavior of materials outside the visible region of the spectrum. For the uninitiated, even relatively simple color infrared imagery can be very confusing. The typical presentation of color infrared imagery makes vegetation appear bright red, water appear black, and road surfaces some shade of blue which can be difficult for many people to interpret.

In order to better interpret imagery including information outside the visible range, analysts have turned to digital imagery and image analysis techniques to extract different information that cannot be easily identified by simple visual inspection. For example, the Normalized Difference Vegetative Index (NDVI) (see, J. W. Rouse, Jr. et al., Monitoring Vegetation Systems in the Great Plains with ERTS, Proceedings of the 3^{rd} ERTS Symposium, NASA SP-351 1, Paper A 20, pp. 309-317), was developed to extract useful information from satellite imagery available in the 1970s. This algorithm computes a value for each pixel in an image containing near infrared and visible radiance data using the formula:

NDVI=(NIR−VIS)/(NIR+VIS)

where “NIR” is the magnitude of near infrared light reflected by the vegetation and “VIS” is the red portion of visible light reflected by the vegetation. Calculations of NDVI for a given pixel always result in a number that ranges from minus one (−1) to plus one (+1). Generally, vegetation responds with an NDVI value of 0.3 or higher with healthier and thicker vegetation approaching a value of 1.

Existing image analysis tools can be used to analyze color infrared imagery and extract NDVI information; however, existing tools provide generic analysis capabilities. A generic analysis capability provides means for skilled image analysts to experiment with new analysis techniques, but may require significant training and expertise as well as a complex manual workflow in order to provide a product that contains easily understood results.

As in the case of the NDVI results, raw analysis results are valuable; however the extracted information is most useful when overlaid on visible imagery or a map product. In this way, areas of healthy vegetation can be visualized easily in a simple, intuitive context (e.g. points on a map). Existing tools provide the ability to overlay image analysis results on other products through a manual process. This capability is typically the domain of a separate geospatial information system, or “GIS”. The process of overlaying NDVI results in most GIS systems is a manual one that involves opening a map product and adding a GIS layer that contains the extracted NDVI information, after which a “final” product containing the merged results may be created for non-expert users.

The generic analysis capabilities in existing image analysis tools and the separate GIS system require a skilled user to follow a manual workflow such as that outlined in FIG. 1. The steps in this prior art process are described below:
1. The user finds the appropriate image to analyze. This could involve the use of a map-based tool, such as ESRI's ArcGIS Image Server or Sanz Earth Where, or may require a manual search through indexed image files (100).
2. Once the user has located the appropriate image, the user opens the image file with the analysis tool, such as ITT's ENVI, and searches for the appropriate area of interest (110).
3. The user selects the analysis to run, or runs a series of analyses, extracting the desired information (160). If the analysis requires input parameters, the user must specify them (140, 150). This analysis may be readily available or can often require some programmatic steps to create the analysis (120, 130).
4. The user determines the visualization method. This may involve finding an appropriate map, often in a separate GIS System, on which to overlay the analysis results, or identification of other imagery to use as a base map (170).
5. The user creates the appropriate output format for the analysis results, defining the final fused product (180).
6. Having the extracted information available and the base map or image, the user must load the components into an appropriate tool to produce the final desired result (190).

Due to the complexities of utilizing the existing generic image analysis tools and the need to visualize the results in a separate GIS system, often users either do not have the skills or time required to extract useful information from imagery and create easily understood results.

There is a need for an improved system and method for analysis and display of geo-referenced imagery. Furthermore, there is a need for such a system and method which automates the production of useful information from remotely sensed imagery without the typical complexity.

### BRIEF SUMMARY OF THE INVENTION

With parenthetical reference to the corresponding parts or portions of the disclosed embodiment, merely for purposes of illustration and not by way of limitation, the present invention provides an improved system, method and computer-readable medium for analysis and display of geo-referenced imagery. In accordance with one aspect of the invention, an image analysis system creates an image or map of a selected area of land by overlaying information (such as land cover type, impervious surface coverage, or health of vegetation) extracted from an image or images onto a base map or image. In another aspect the system creates fused data products based on geo-referenced visible light imagery or a map and information extracted from other available image sources. In one aspect in particular, the system and method analyzes and displays information extracted from color infrared imagery comprised of spectral radiation in the visible and near infrared portions of the electromagnetic spectrum.

The system and method receives or takes input from a user (e.g. a user inputting instructions or selecting options at a PC or computer terminal) regarding the location on the earth for which the data product should be produced. In another aspect, the system and method identifies the appropriate image or images from a geospatially indexed database of imagery. Image(s) identified through the geospatial database may be automatically analyzed by the system using spectral or spatial techniques to extract useful information from the image(s). In one aspect of the invention, the automatic analysis produces an image where each pixel represents a spatial or spectral property of the same pixel location in the original analyzed image. The resulting image may be transformed automatically either into a vector representation or an image with transparency based on the target display system. A semi-transparent image or vector map may be automatically overlaid on the desired base map or image.

One aspect of the present invention provides a method for automatically generating a geo-referenced imagery display, comprising: maintaining a spatially-indexed image database having a plurality of images corresponding to a plurality of geographic locations; accepting a user-specified geographic location through an interactive graphical user interface; accepting a user-specified extraction analysis for application upon images corresponding to the user-specified geographic location through the graphical user interface; automatically executing such user-specified extraction analysis to extract overlay information from such images corresponding to the user-specified geographic location(s); and automatically overlaying such extracted overlay information on a geo-referenced image, and displaying the overlaid geo-referenced image though the graphical user interface. In one aspect, such layered geospatial information includes land cover type superimposed on a base map or image. In another aspect, it includes impervious surface coverage superimposed on a base map or image. In yet another aspect, it includes indications of relative vegetative health superimposed on a base map or image. In yet another aspect, such layered geospatial information is displayed through a graphical user interface on a computer monitor.

Certain aspects of the invention also include a computer-readable medium having computer-executable instructions for performing the foregoing method and/or method steps, including a computer-assisted method of performing same and/or a software package, computerized system and/or web-based system for performing same. As used herein, computer-readable medium includes any kind of computer or electronic memory, storage or software including without limitation floppy discs, CD-ROMs, DVDs, hard disks, flash ROM, nonvolatile ROM, SD memory, RAIDS, SANs, LANs etc. as well as internet servers and any means of storing or implementing software or computer instructions, and the display of results on a monitor, screen or other display device.

From the user's perspective, one aspect of the method and system disclosed herein reduces the effort required to analyze available imagery to: (1) selecting the location for analysis on an image or map; (2) choosing the analysis to run; and (3) viewing the results as an overlay on the original image or map.

A general object of the invention is to automate the production of useful information from remotely sensed imagery without complexity. It is another object of this invention to produce a product that is more easily understood and analyzed than the original image and map products separately. It is a further object to provide a data product that will provide a user having minimal training with the ability to take advantage of images that have previously been of use only to those with significant experience, skill, and training.

These and other objects and advantages will become apparent from the foregoing and ongoing written specification, the accompanying drawings and the appended claims.

### BRIEF DESCRIPTION OF DRAWINGS

FIG. 1 is a flow chart illustrating a prior art image analysis system.

FIG. 2 is a schematic representing the components comprising a preferred embodiment of the invention.

FIG. 3 is a flow chart illustrating the process followed by an overlay generator in one embodiment of the invention.

FIG. 4 is a depiction of a scene that a user may want to analyze.

FIG. 5 is an overlay generated for the scene in FIG. 4.

FIG. 6 is a depiction of a product created through the overlay of FIG. 5 on FIG. 4.

FIG. 7 is a graphical user interface window.

FIG. 8 is a graphical user interface window indicating that analysis options have been set to values other than default.

FIG. 9 is an options window for a vegetative coverage map.

FIG. 10 is an options window for a vegetative absence map.

FIG. 11 is an options window for a vegetative contour map.

FIG. 12 is an analysis tab of a settings window.

FIG. 13 is an output tab of a settings window.

FIG. 14 is a dialog window allowing a user to update the location for storing analysis results.

FIG. 15 is a tool allowing a user to modify the opacity of displayed overlays.

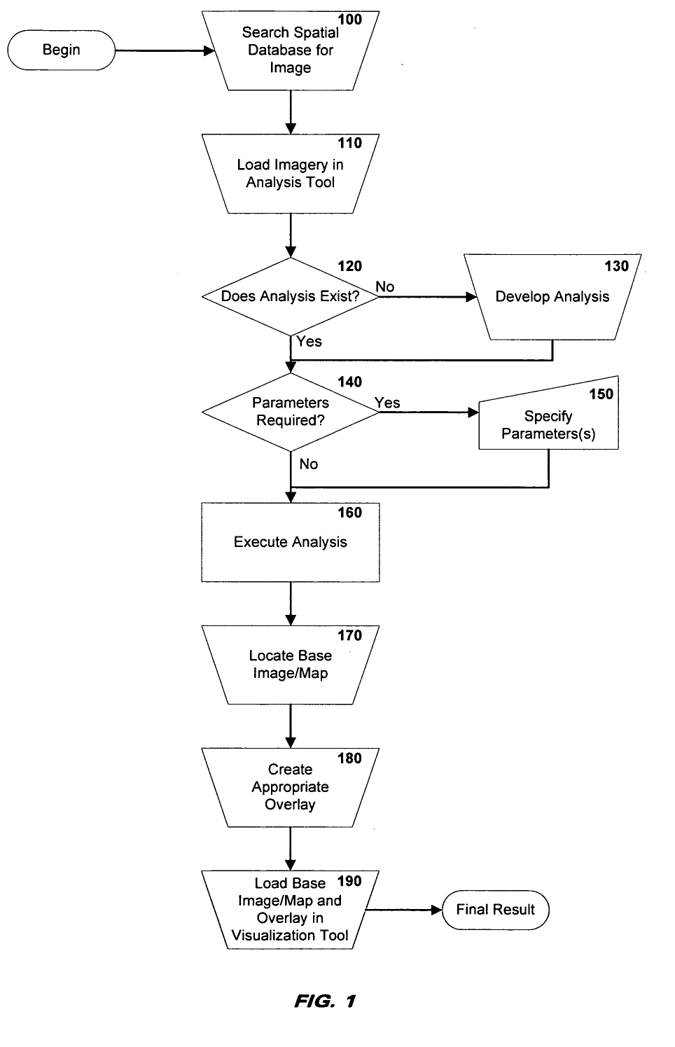

### DESCRIPTION OF THE PREFERRED EMBODIMENTS

At the outset, it should be clearly understood that like reference numerals are intended to identify the same parts, elements or portions consistently throughout the several drawing figures, as such parts, elements or portions may be further described or explained by the entire written specification, of which this detailed description is an integral part. The following description of the preferred embodiments of the present invention are exemplary in nature and are not intended to restrict the scope of the present invention, the manner in which the various aspects of the invention may be implemented, or their applications or uses.

A preferred embodiment relates generally to a method for automatically extracting information from imagery and creating an overlay appropriate for display over a map or other imagery to produce a composite data product. Other embodiments relate to a system and computer-readable medium with computer-executable instructions for same. In the embodiments described, information is extracted from color infrared imagery containing three bands of information spanning the visible (green and red) portion of the spectrum as well as the near infrared. The invention is not to be limited in scope to the analysis of color infrared imagery, as analysis of higher dimensional multi-spectral imagery or hyperspectral imagery may also be performed.

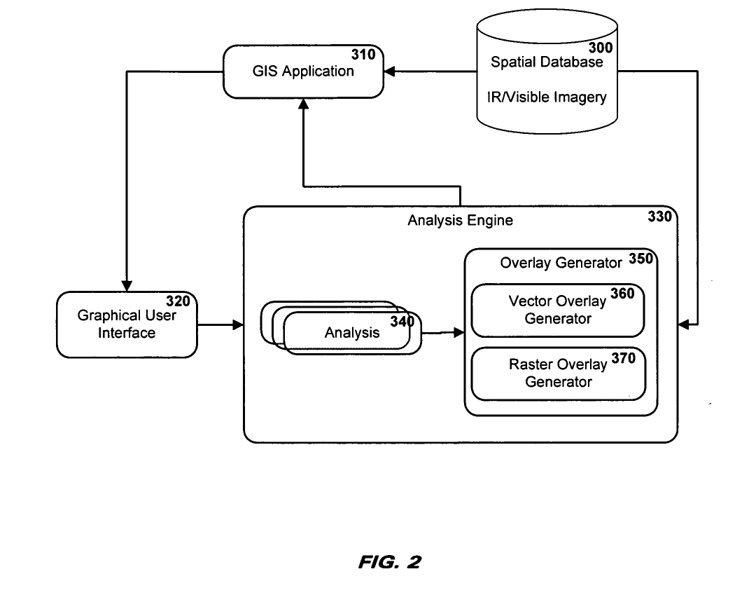

FIG. 2 is a flowchart representing the architectural software components comprising a preferred embodiment of the invention. Referring now to FIG. 2, the system of this embodiment includes a spatially-indexed image database 300. This database contains all of the imagery that may be analyzed for a particular region of interest. This region of interest may encompass several small disjoint areas of the earth, a specific contiguous land area, or the entire surface of the earth, provided appropriate storage. With relation to the present embodiment, this spatially indexed database of imagery provides an interface allowing for the automatic identification of all images that intersect a particular point or region provided as input by the user. Several technologies may be employed for the image database (e.g., ESRI's ArcGIS Image Server, Oracle Spatial, etc.) provided that the specified requirements (such as supporting spatial queries for imagery based on point or area selections) are met. The image database is configured to contain a set of images that, when tiled together, cover an area of the earth that is of interest to the user or users of the invention.

Again referring to FIG. 2, the system of this embodiment includes a GIS application 310, which is a system capable of displaying layered geospatial information and accepting input from the user regarding a point or area of interest to the user. In a preferred embodiment, a GIS application acts as the host application, providing the user with the tools necessary to identify and select a position on the surface of the earth to analyze. Once the analysis has been completed, this tool will also provide the means to display the output of the process as an overlay on the imagery or maps displayed during the initial process of identifying the area to be analyzed.

FIG. 2 also illustrates a user interface 320 on the computer that allows the user to choose the desired analysis. For each analysis, the user interface 320 provides a mechanism for the user to adjust the options or parameters available for the selected analysis. In the preferred embodiment, this interface is a graphical user interface deployed on the user's personal computer. In a different embodiment, the entire image viewing, analysis, and overlay processes could be hosted on a server and performed through a network, browser or other remote interface.

The core analysis engine 330 employed in this embodiment is responsible for using the input information provided by the user to initiate a search for appropriate imagery, display a graphical interface for accepting additional input from the user, coordinating the analysis of the imagery, and communicating the results of the analysis back to the GIS Application 310.

In this embodiment, the analysis engine 330 searches the spatial image database to identify imagery available to be analyzed. In a preferred embodiment, this imagery data consists of ortho-rectified color infrared imagery. The imagery, however, could be ortho-rectified multispectral or hyperspectral imagery. In some cases, geo-rectified imagery may be used but the accuracy of the resulting overlay may suffer, particularly in areas with significant changes in elevation.

The search for the imagery may be performed based on either a point or an area of interest. When selecting a specific point, the search identifies every image in the image database that contains the selected point. When selecting an area of interest, the system will identify all images that intersect the specified area.

Item 340 in FIG. 2 represents a number of different analyses. There are a number of different analyses that could be used in this embodiment to produce results that may be useful under a variety of circumstances. In general, this embodiment supports the insertion of any analysis capable of transforming the spatial and spectral properties of an input image into an identically sized image highlighting some property of interest to the user. Examples of these types of analysis include estimates of impervious surface coverage, maps of vegetative health, land classifications, estimates of fuel loading, etc.

After an image has been analyzed, the analysis engine 330 converts the results of the analysis into an overlay designed for display over existing imagery or maps, through an overlay generator 350. There are two types of overlay that may be generated in this preferred embodiment. One embodiment generates vector based overlays 360, and another preferred embodiment creates raster based overlays 370. As known to those skilled in the art, a raster overlay consists of a regular grid of elements, often referred to as pixels, matching the dimensions of the image being analyzed. For each position in the grid, the analysis generates a value representing the color and transparency of that position. In contrast, a vector overlay consists of geometric primitives such as points, lines, curves, and polygons to represent an image. A raster image may be converted to vectors by computing geometric primitives for each set of identical adjacent pixels. Similarly, a vector image may be converted to a raster by defining a grid size and assigning each pixel a color based on the color of the geometric primitive containing that pixel.

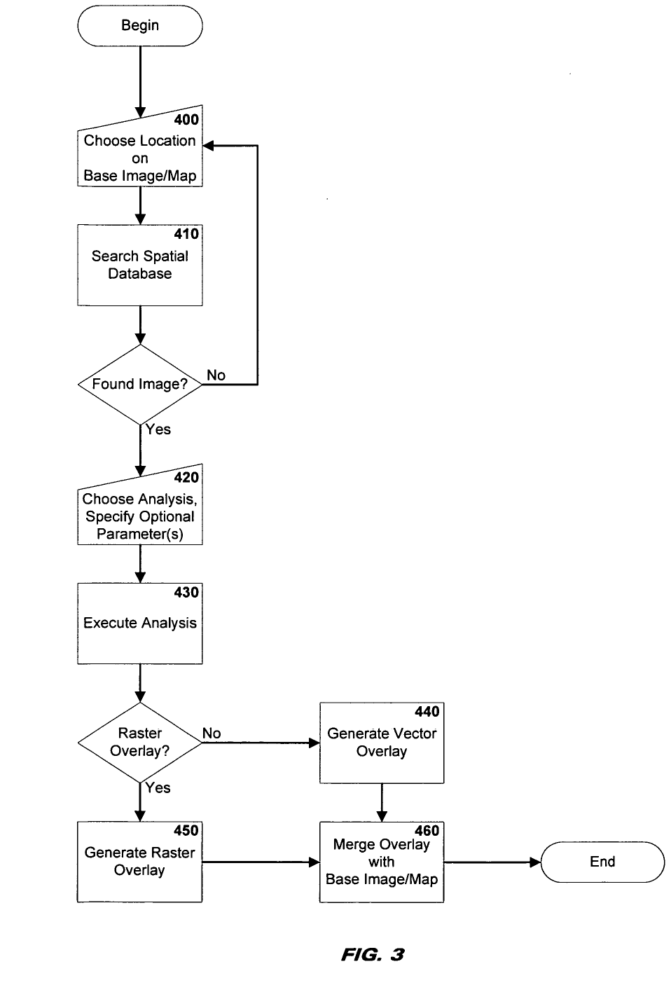

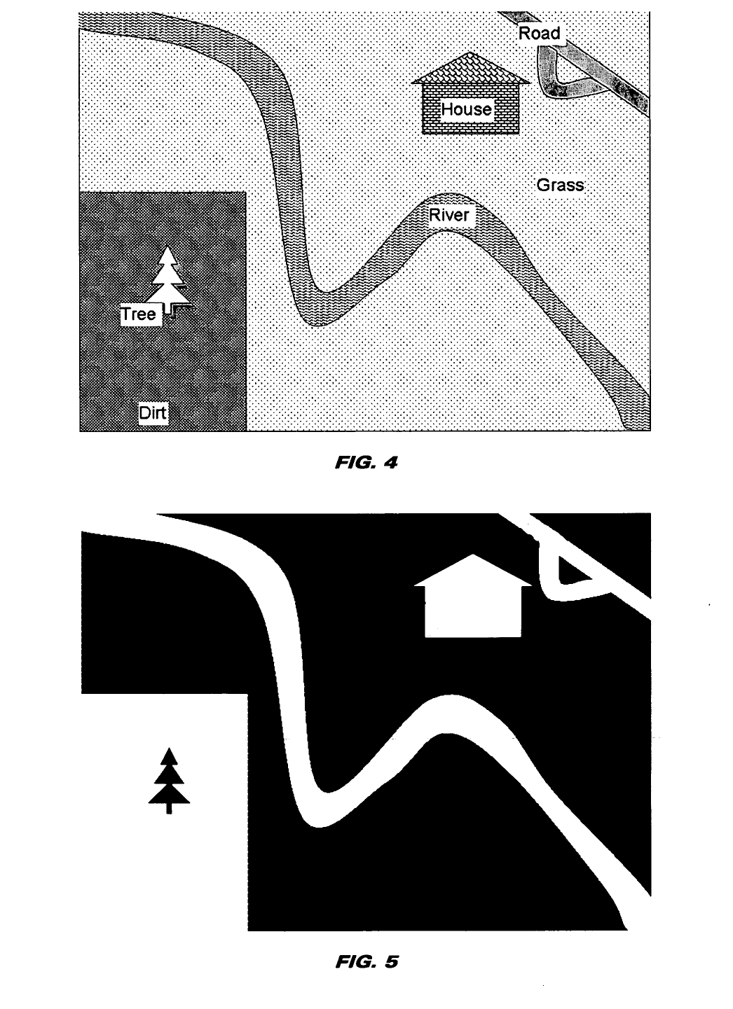

FIG. 3 depicts the process followed by the overlay generator 350 of a preferred embodiment in the creation of an overlay. Block 400 represents the first step of the method or process wherein the user specifies an area of interest for analysis. In a preferred embodiment, the user performs this selection process by indicating the area to analyze on a properly geo-referenced ortho or oblique visible image of the area, and the system of this embodiment receives and processes such selection. FIG. 4 is an example of the type of area that a user may choose to analyze.

Block 410 represents the internal process used by the system to identify the appropriate imagery for analysis. This process involves searching through a database of available imagery to identify the image or images that overlap the current area of interest. In the preferred embodiment, the imagery for analysis is color infrared imagery captured by either aerial or satellite based systems. The system and method of this preferred embodiment determines if any imagery is available for analysis by searching for images whose geospatial extents overlap the current area of interest. In this embodiment, this area of interest is defined as a single point. The system determines if any imagery is available for analysis. If no imagery is available, the system informs the user and allows the user to select a new location 400.

If appropriate imagery has been found, the system presents the user with a user interface appropriate for the platform hosting the image analysis 420. This interface allows the user to choose the analysis to execute. Having chosen the desired analysis to perform, the user may either choose to immediately execute with the last set of parameters used for the selected analysis or configure the options for the analysis. Once the user has selected the proper analysis and potentially set parameters for the analysis (at 420), the system executes the selected analysis 430.

With the analysis chosen, the system begins the process of extracting information from the original image identified in the search (at 410). The analysis process transforms the spatial and/or spectral information available in the input image into a new image that can be presented to the user as an overlay over existing imagery or maps. In two embodiments, two different but related analyses have been developed. The first involves the transformation of each pixel in the input image through spectral analysis. For each pixel in the input image, the Normalized Difference Vegetative Index (NDVI) is computed. This well known value is frequently used to identify the relative health or vigor of vegetation in the scene. The NDVI value is computed as a normalized difference between the infrared and red portions of the visible spectrum recorded in the input image. The NDVI values is calculated as (NIR−R)/(NIR+R) where “NIR” is the near infrared value recorded by the sensor and “R” is the red value for the same pixel. This calculation results in a real number in a range between −1 and 1.

Frequently, the NDVI analysis results in a grayscale image through a linear transformation mapping −1 values to black and +1 values to white. In order to facilitate the creation of an overlay, the NDVI image is further processed using a threshold. The threshold value is used to separate the pixels into two classes. With an appropriate threshold value, these two classes can be considered to represent vegetation and non-vegetation. By adjusting the threshold, the user may adjust the classification of different elements of the image. Typically, the value of the threshold should be approximately a value of 0.3 with NDVI values greater than 0.3 representing vegetation. Depending on the details of the collection of the source imagery this value may need to be adjusted by the user through the analysis user interface. FIG. 5 represents an overlay which may be generated in a preferred embodiment; this overlay covers the vegetative areas of the scene in the example of FIG. 4.

Another preferred analysis uses the same initial calculation of the NDVI image and the application of a threshold value. For this analysis, the user does not merely supply the threshold to separate vegetation from non-vegetation but also supplies a number of additional divisions for the vegetation. The pixels in the image are divided into (segments +1) different classes with all pixels below the threshold value in one non-vegetation class and all other pixels divided into “segment” number of classes with each segment representing an equal division of the NDVI value between the threshold value and 1. For example, with a threshold of 0.3 and a choice of 2 segments by the user, three classes of NDVI pixels are created: those with values less than 0.3, pixels with values between 0.3 and 0.65, and pixels with values between 0.65 and 1.

After the analysis process in Block 430 completes, the system and method makes a decision regarding the type of overlay to be generated. In a preferred embodiment, the overlays generated are vector-based representations of the raster created by representing each class of pixels identified by the analysis as a different color. In the case of the two class versions created with a single threshold value, the vector representation can either represent the coverage of the values above or below the threshold depending on the users desire to visualize areas of vegetation or non-vegetation. In the case of the vegetation contour map generated by the multiple segment analysis, a separate vector representation is created for each class defined above the specified threshold value. Each of these overlays is created in the process identified at Block 440 in FIG. 3.

At Block 450, an alternate process is implemented for creating the overlay based on the information generated by the analysis process. In this case, the final overlay is left in the same raster format generated by the analysis at Block 430 except for adjustments made to the transparency of the raster. For example, in the simple case of separating vegetation from non-vegetation, the non-vegetation class can be made completely transparent, allowing the user to view the overlay of the vegetated areas with the non-vegetated areas such as buildings displayed completely to provide appropriate context.

The end state in the embodiment illustrated in FIG. 3 consists of display of the generated raster overlay in a visualization tool capable of displaying the output of the process as a layer on top of existing imagery or maps 460. In a preferred embodiment, the generated overlays are displayed over oblique or ortho imagery to provide the user with appropriate context for understanding and investigating the information extracted from the available color infrared imagery. FIG. 6 represents an example of this end state with the analysis results from FIG. 5 overlaid on the original scene from FIG. 4.

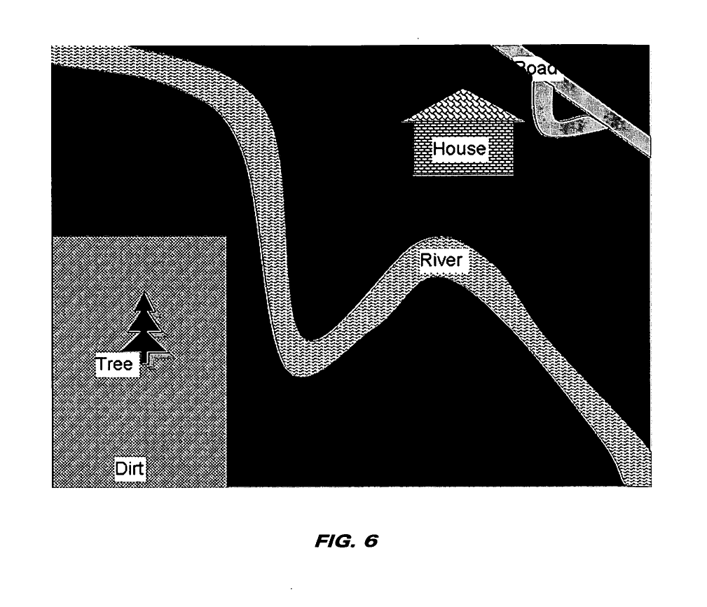

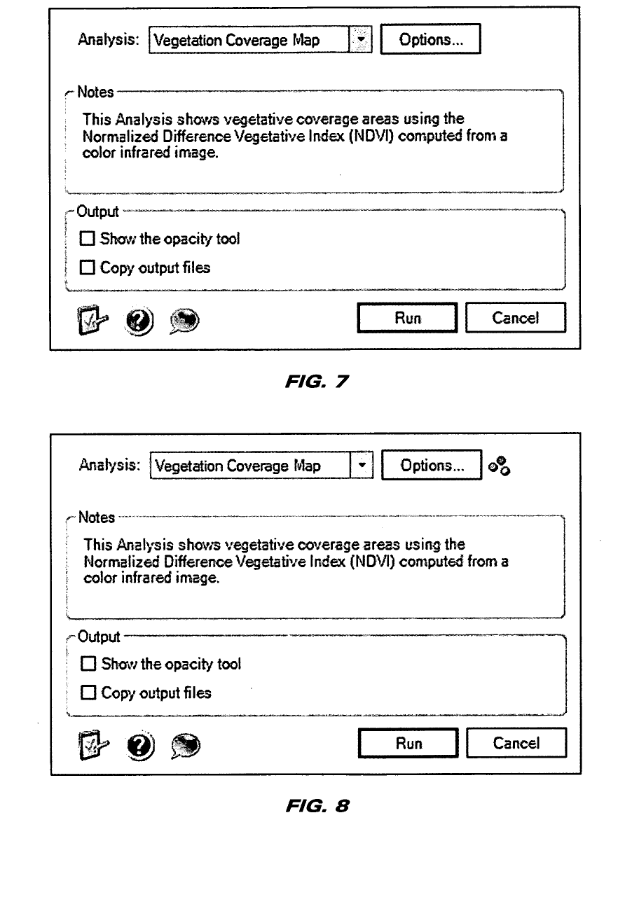

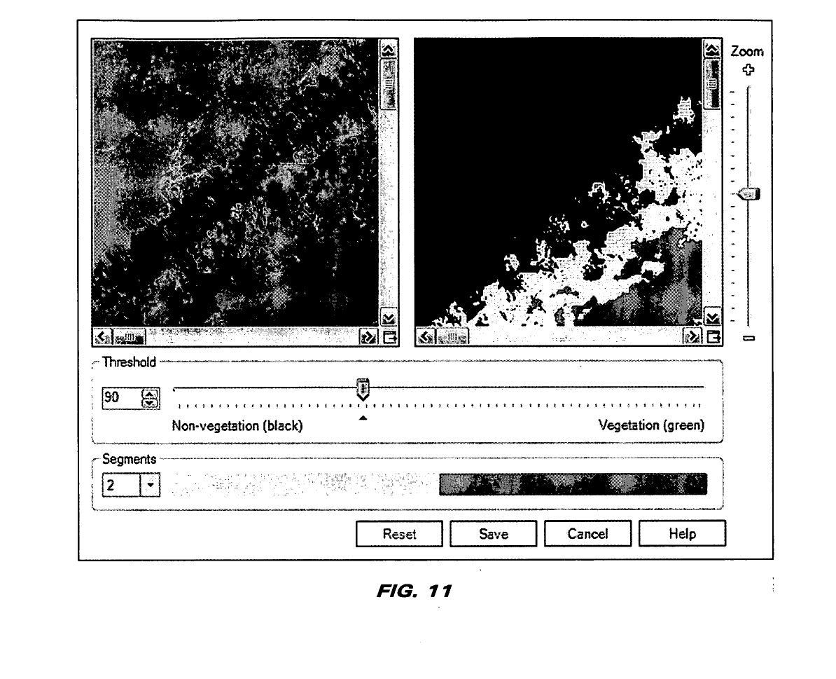

Referring now to FIGS. 7 through 15, the graphical user interface for the system and method in a preferred embodiment includes several distinct screens. FIG. 7 illustrates a window displayed in a preferred embodiment of the present invention wherein a user selects an intended analysis (e.g vegetation coverage map, land cover type, impervious surface coverage, health of vegetation, etc.), analysis options (e.g. vegetative health threshold, sensitivity, number of land cover classes, etc.) and configuration of output (e.g. display opacity tool, copy output files to a specific location, etc.), among other things.

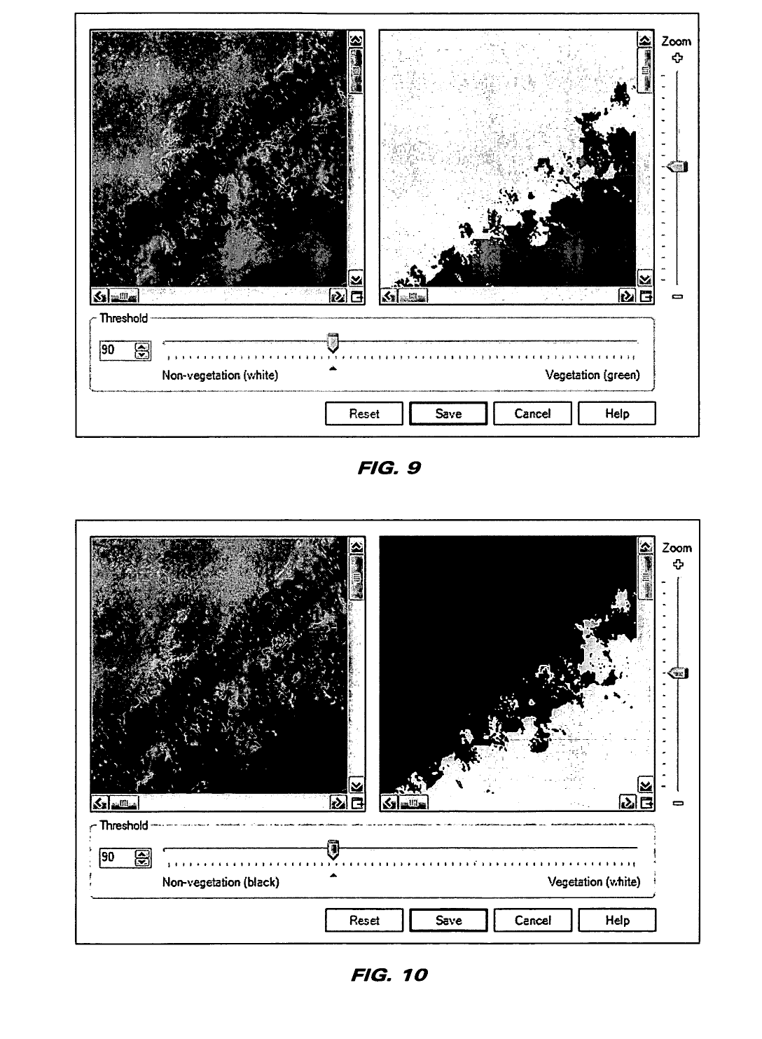

In one preferred embodiment, each analysis has its own options window selected from the main window of FIG. 7. An options window displays parameters that affect the behavior of the currently selected analysis, as illustrated in FIGS. 9, 10 and 11. In one embodiment, such options windows are separate and resizable, and default analysis options have been specified for each analysis. FIG. 8 illustrates an additional small icon displayed on the analysis selection window when options for the currently selected analysis have been altered from those default values.

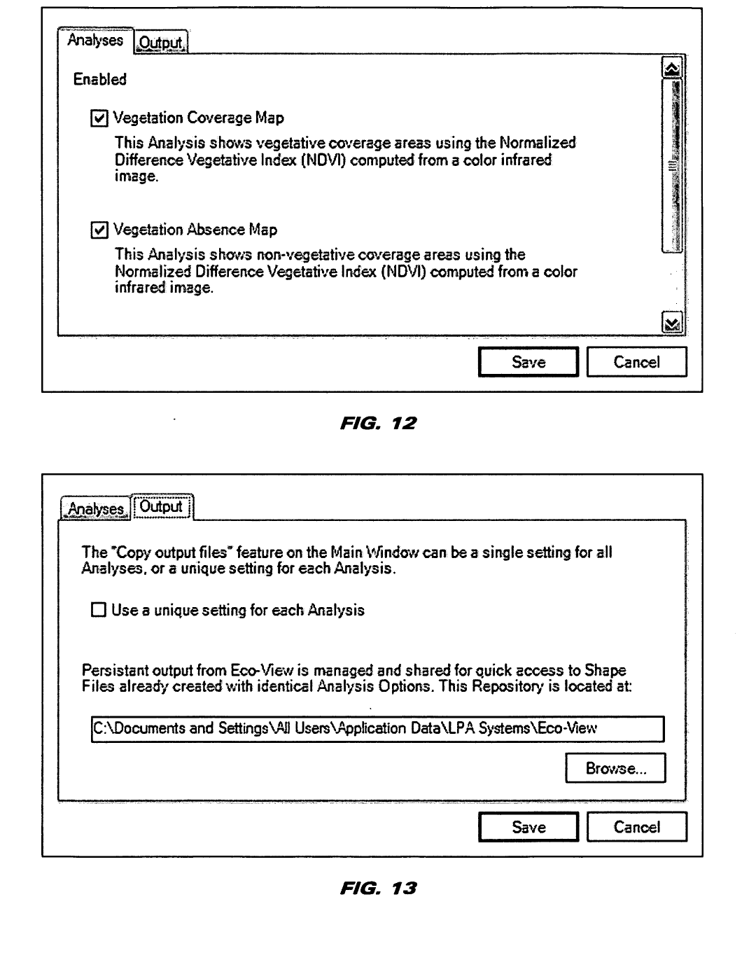

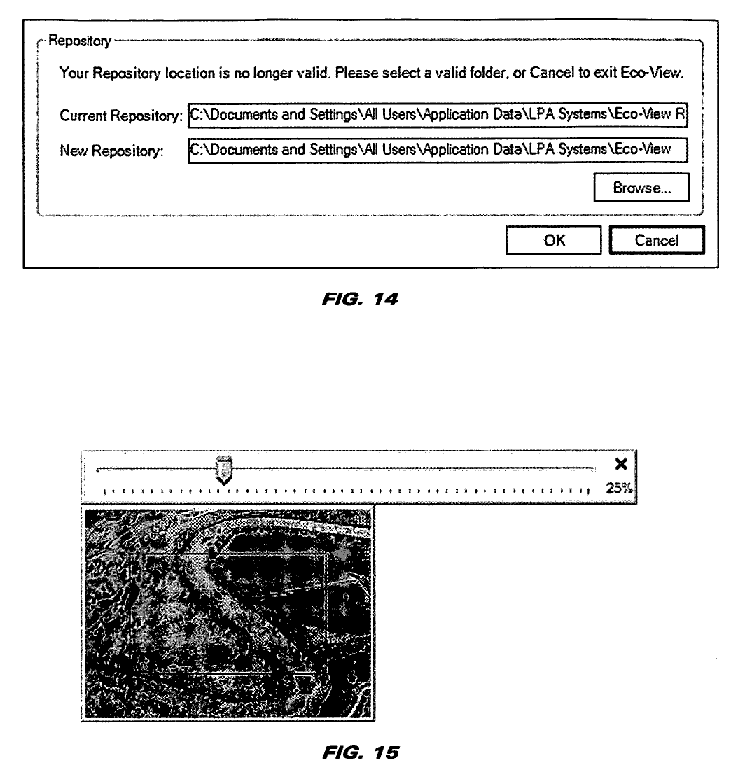

In certain aspects, a user may select analyses for display in the selection window of FIG. 7 and output settings, as illustrated in FIGS. 12 and 13. Examples of such analyses are a vegetation coverage map which shows vegetative coverage areas using the NDVI computed from a color infrared image, and a vegetation absence map which shows non-vegetative coverage areas using the NDVI computed from a color infrared image. Examples of user-selectable output settings include a setting to control the behavior of the “copy output files” feature on the main window of FIG. 7 and configuration of the persistent output location which manages analysis results for quick, shared access. In certain aspects, a user may lose access to the persistent storage location used by the preferred embodiment of the invention; FIG. 14 illustrates a graphical user interface allowing the user to reconfigure the persistent storage location when this situation occurs. In addition, as illustrated in FIG. 15, a preferred embodiment of the invention includes an “opacity” tool, which is a floating, on-top window which affects the opacity property of all layers generated by this embodiment.

While there has been described what is believed to be the preferred embodiment of the present invention, those skilled in the art will recognize that other and further changes and modifications may be made thereto without departing from the spirit or scope of the invention. Therefore, the invention is not limited to the specific details and representative embodiments shown and described herein and may be embodied in other specific forms. The present embodiments are therefore to be considered as illustrative and not restrictive, the scope of the invention being indicated by the appended claims rather than by the foregoing description, and all changes which come within the meaning and range of the equivalency of the claims are therefore intended to be embraced therein. In addition, the terminology and phraseology used herein is for purposes of description and should not be regarded as limiting.

1: A computer-implemented method for automatically generating a geo-referenced imagery display, comprising:
maintaining a spatially-indexed image database having a plurality of images corresponding to a plurality of geographic locations;
accepting a user-specified geographic location through an interactive graphical user interface;
accepting a user-specified extraction analysis for application upon said images corresponding to said user-specified geographic location through said graphical user interface;
automatically executing said user-specified extraction analysis to extract overlay information from said images corresponding to said user-specified geographic location; and
automatically overlaying said extracted overlay information on a geo-referenced image, and displaying said extracted overlay information and said geo-referenced image through said graphical user interface such that both said extracted overlay information and said geo-referenced image are visible.

2: The method of claim 1, further comprising:
automatically converting said overlay information into a vector representation.

3: The method of claim 1, further comprising:
automatically converting said overlay information into a raster.

4: The method of claim 3 wherein each of said images corresponding to said user-specified geographic location consists of a plurality of pixels, further comprising:
generating an overlay image having transparency values and color values corresponding to each of said pixels.

5: The method of claim 3, further comprising:
converting said raster into a vector representation.

6: The method of claim 1 wherein said extraction analysis comprises extracting overlay information comprising estimates of impervious surface coverage corresponding to said user-specified geographic location.

7: The method of claim 1 wherein said geo-referenced image is a map.

8: The method of claim 1 wherein said overlay information is the Normalized Difference Vegetative Index, land cover type, impervious surface coverage or fuel loading corresponding to said user-specified geographic location.

9: The method of claim 1 wherein said image database comprises color infrared imagery, near infrared imagery, multi-spectral imagery or hyperspectral imagery.

10: The method of claim 1, further comprising:
accepting at least one user-specified vegetation classification; and
automatically converting said overlay information into a plurality of vector representations corresponding to each of said user-specified vegetation classifications;
wherein said extraction analysis extracts overlay information corresponding to each of said user-specified vegetation classifications.

11: The method of claim 1, further comprising:
accepting at least one user-specified vegetation classification; and
automatically converting said overlay information into a raster reflecting each of said user-specified vegetation classifications;
wherein said extraction analysis extracts overlay information corresponding to each of said user-specified vegetation classifications.

12: A computer-readable medium having computer-executable instructions for performing a method comprising:
maintaining a spatially-indexed image database having a plurality of images corresponding to a plurality of geographic locations;
accepting a user-specified geographic location through an interactive graphical user interface;
accepting a user-specified extraction analysis for application upon said images corresponding to said user-specified geographic location through said graphical user interface;
automatically executing said user-specified extraction analysis to extract overlay information from said images corresponding to said user-specified geographic location; and
automatically overlaying said extracted overlay information on a geo-referenced image, and displaying said extracted overlay information and said geo-referenced image through said graphical user interface such that both said extracted overlay information and said geo-referenced image are visible.

13: The computer-readable medium of claim 12, further comprising:
automatically converting said overlay information into a vector representation.

14: The computer-readable medium of claim 12, further comprising:
automatically converting said overlay information into a raster.

15: The computer-readable medium of claim 14 wherein each of said images corresponding to said user-specified geographic location consists of a plurality of pixels, further comprising:
generating an overlay image having transparency values and color values corresponding to each of said pixels.

16: The computer-readable medium of claim 14, further comprising:
converting said raster into a vector representation.

17: The computer-readable medium of claim 12 wherein said extraction analysis comprises extracting overlay information comprising estimates of impervious surface coverage corresponding to said user-specified geographic location.

18: The computer-readable medium of claim 12 wherein said geo-referenced image is a map.

19: The computer-readable medium of claim 12 wherein said overlay information is the Normalized Difference Vegetative Index, land cover type, impervious surface coverage or fuel loading corresponding to said user-specified geographic location.

20: The computer-readable medium of claim 12 wherein said image database comprises color infrared imagery, near infrared imagery, multi-spectral imagery or hyperspectral imagery.

21: The computer-readable medium of claim 12, further comprising:
accepting at least one user-specified vegetation classification; and
automatically converting said overlay information into a plurality of vector representations corresponding to each of said user-specified vegetation classifications;
wherein said extraction analysis extracts overlay information corresponding to each of said user-specified vegetation classifications.

22: The computer-readable medium of claim 12, further comprising:
accepting at least one user-specified vegetation classification; and
automatically converting said overlay information into a raster reflecting each of said user-specified vegetation classifications;
wherein said extraction analysis extracts overlay information corresponding to each of said user-specified vegetation classifications.

23: A system for automatically generating a geo-referenced imagery display, comprising:
a spatially-indexed image database operative to maintain a plurality of images corresponding to a plurality of geographic locations;
an interactive graphical user interface operative to accept a user-specified geographic location and a user-specified extraction analysis for application upon said images;
an analysis engine operative to automatically execute said user-specified extraction analysis to extract overlay information from said images and to overlay said extracted overlay information on a geo-referenced image; and
a display device operative to display said extracted overlay information and said geo-referenced image through said graphical user interface such that both said extracted overlay information and said geo-referenced image are visible.

24: The system of claim 23, further comprising:
a vector overlay generator operative to generate said extracted overlay information.

25: The system of claim 23, further comprising:
a raster overlay generator operative to generate said extracted overlay information.

26: The method of claim 1 wherein said geo-referenced image is oblique imagery.

27: The method of claim 1 wherein said geo-referenced image is ortho imagery.

28: The method of claim 1 wherein said extracted overlay information is transparent.

29: The method of claim 1 wherein said extracted overlay information is semitransparent.

30: The method of claim 1 wherein said extraction analysis comprises extracting overlay information comprising estimates of vegetation health derived from the Normalized Difference Vegetative Index corresponding to said user-specified geographic location.

31: The method of claim 1 wherein said extraction analysis comprises extracting overlay information comprising estimates of land classifications corresponding to said user-specified geographic location.

32: The method of claim 1 wherein the extraction analysis comprises extracting overlay information comprising estimates of fuel loading corresponding to said user-specified geographic location.

33: The computer-readable medium of claim 12 wherein said geo-referenced image is oblique imagery.

34: The computer-readable medium of claim 12 wherein said geo-referenced image is ortho imagery.

35: The computer-readable medium of claim 12 wherein said extracted overlay information is transparent.

36: The computer-readable medium of claim 12 wherein said extracted overlay information is semitransparent.

37: The computer-readable medium of claim 12 wherein said extraction analysis comprises extracting overlay information comprising estimates of vegetation health derived from the Normalized Difference Vegetative Index corresponding to said user-specified geographic location.

38: The computer-readable medium of claim 12 wherein said extraction analysis comprises extracting overlay information comprising estimates of land classifications corresponding to said user-specified geographic location.

39: The computer-readable medium of claim 12 wherein the extraction analysis comprises extracting overlay information comprising estimates of fuel loading corresponding to said user-specified geographic location.

40: A computer-implemented method for automatically generating a geo-referenced imagery display, comprising:
maintaining a spatially-indexed image database having a plurality of hyperspectral images corresponding to a plurality of geographic locations;
accepting a user-specified geographic location through an interactive graphical user interface;
accepting a user-specified extraction analysis for application upon said hyperspectral images corresponding to said user-specified geographic location through said graphical user interface;
automatically executing said user-specified extraction analysis to extract overlay information from said hyperspectral images corresponding to said user-specified geographic location; and
automatically overlaying said extracted overlay information on a geo-referenced image, and displaying said extracted overlay information and said geo-referenced image through said graphical user interface.

41: The method of claim 40 wherein both said extracted overlay information and said geo-referenced image are visible in said displaying step.

42: The method of claim 40, further comprising:
automatically converting said overlay information into a vector representation.

43: The method of claim 40, further comprising:
automatically converting said overlay information into a raster.

44: The method of claim 43 wherein each of said hyperspectral images corresponding to said user-specified geographic location consists of a plurality of pixels, further comprising:
generating an overlay image having transparency values and color values corresponding to each of said pixels.

45: The method of claim 43, further comprising:
converting said raster into a vector representation.

46: The method of claim 40 wherein said extraction analysis comprises extracting overlay information comprising estimates of impervious surface coverage corresponding to said user-specified geographic location.

47: The method of claim 40 wherein said extraction analysis comprises extracting overlay information comprising estimates of vegetation health derived from the Normalized Difference Vegetative Index corresponding to said user-specified geographic location.

48: The method of claim 40 wherein said extraction analysis comprises extracting overlay information comprising estimates of land classifications corresponding to said user-specified geographic location.

49: The method of claim 40 wherein the extraction analysis comprises extracting overlay information comprising estimates of fuel loading corresponding to said user-specified geographic location.

50: The method of claim 40 wherein said geo-referenced image is a map.

51: The method of claim 40 wherein said geo-referenced image is oblique imagery.

52: The method of claim 40 wherein said geo-referenced image is ortho imagery.

53: The method of claim 40 wherein said extracted overlay information is transparent.

54: The method of claim 40 wherein said extracted overlay information is semitransparent.

55: The method of claim 40, further comprising:
accepting at least one user-specified vegetation classification; and
automatically converting said overlay information into a plurality of vector representations corresponding to each of said user-specified vegetation classifications;
wherein said extraction analysis extracts overlay information corresponding to each of said user-specified vegetation classifications.

56: The method of claim 40, further comprising:
accepting at least one user-specified vegetation classification; and
automatically converting said overlay information into a raster reflecting each of said user-specified vegetation classifications;
wherein said extraction analysis extracts overlay information corresponding to each of said user-specified vegetation classifications.

57: A computer-readable medium having computer-executable instructions for performing a method comprising:
maintaining a spatially-indexed image database having a plurality of hyperspectral images corresponding to a plurality of geographic locations;
accepting a user-specified geographic location through an interactive graphical user interface;
accepting a user-specified extraction analysis for application upon said hyperspectral images corresponding to said user-specified geographic location through said graphical user interface;
automatically executing said user-specified extraction analysis to extract overlay information from said hyperspectral images corresponding to said user-specified geographic location; and
automatically overlaying said extracted overlay information on a geo-referenced image, and displaying said extracted overlay information and said geo-referenced image through said graphical user interface.

58: The computer-readable medium of claim 57 wherein both said extracted overlay information and said geo-referenced image are visible in said displaying step.

59: The computer-readable medium of claim 57, further comprising:
automatically converting said overlay information into a vector representation.

60: The computer-readable medium of claim 57, further comprising:
automatically converting said overlay information into a raster.

61: The computer-readable medium of claim 60 wherein each of said hyperspectral images corresponding to said user-specified geographic location consists of a plurality of pixels, further comprising:
generating an overlay image having transparency values and color values corresponding to each of said pixels.

62: The computer-readable medium of claim 60, further comprising:
converting said raster into a vector representation.

63: The computer-readable medium of claim 57 wherein said extraction analysis comprises extracting overlay information comprising estimates of impervious surface coverage corresponding to said user-specified geographic location.

64: The computer-readable medium of claim 57 wherein said extraction analysis comprises extracting overlay information comprising estimates of vegetation health derived from the Normalized Difference Vegetative Index corresponding to said user-specified geographic location.

65: The computer-readable medium of claim 57 wherein said extraction analysis comprises extracting overlay information comprising estimates of land classifications corresponding to said user-specified geographic location.

66: The computer-readable medium of claim 57 wherein the extraction analysis comprises extracting overlay information comprising estimates of fuel loading corresponding to said user-specified geographic location.

67: The computer-readable medium of claim 57 wherein said geo-referenced image is a map.

68: The computer-readable medium of claim 57 wherein said geo-referenced image is oblique imagery.

69: The computer-readable medium of claim 57 wherein said geo-referenced image is ortho imagery.

70: The computer-readable medium of claim 57 wherein said extracted overlay information is transparent.

71: The computer-readable medium of claim 57 wherein said extracted overlay information is semitransparent.

72: The computer-readable medium of claim 57, further comprising:
accepting at least one user-specified vegetation classification; and
automatically converting said overlay information into a plurality of vector representations corresponding to each of said user-specified vegetation classifications;
wherein said extraction analysis extracts overlay information corresponding to each of said user-specified vegetation classifications.

73: The computer-readable medium of claim 57, further comprising:
accepting at least one user-specified vegetation classification; and
automatically converting said overlay information into a raster reflecting each of said user-specified vegetation classifications;
wherein said extraction analysis extracts overlay information corresponding to each of said user-specified vegetation classifications.

74: A system for automatically generating a geo-referenced imagery display, comprising:
a spatially-indexed image database operative to maintain a plurality of hyperspectral images corresponding to a plurality of geographic locations;
an interactive graphical user interface operative to accept a user-specified geographic location and a user-specified extraction analysis for application upon said hyperspectral images;
an analysis engine operative to automatically execute said user-specified extraction analysis to extract overlay information from said hyperspectral images and to overlay said extracted overlay information on a geo-referenced image; and
a display device operative to display said extracted overlay information and said geo-referenced image through said graphical user interface.

75: The system of claim 74, further comprising:
a vector overlay generator operative to generate said extracted overlay information.

76: The system of claim 74, further comprising:
a raster overlay generator operative to generate said extracted overlay information.
